(19) United States
(12) Patent Application Publication
(10) Pub. No.: US 2008/0089486 A1
(43) Pub. Date: Apr. 17, 2008

(54) TEMPORARY EMERGENCY CALL BACK IDENTIFIER

(75) Inventors: Lila Madour, Kirkland (CA); Eric Turcotte, Verdun (CA)

Correspondence Address: ERICSSON CANADA INC.;PATENT DEPARTMENT, 8400 DECARIE BLVD., TOWN MOUNT ROYAL, QC, H4P 2N2, US

(73) Assignee: TELEFONAKTIEBOLAGET LM ERICSSON (PUBL), Stockholm (SE)

(21) Appl. No.: 11/556,885

(22) Filed: Nov. 6, 2006

Related U.S. Application Data
(60) Provisional application No. 60/852,010, filed on Oct. 17, 2006.

(51) Int. Cl. H04M 11/04

(52) U.S. Cl. 379/45

(57) ABSTRACT

A method and node for providing a temporary emergency call back identifier to a User Equipment (UE) for use by an emergency assistance provider. Based on an emergency registration indication, a temporary emergency call back identifier is assigned to the UE. The temporary emergency call back identifier is valid for a period of time that does not exceed the duration of the emergency registration. Temporary emergency call back identifiers could be maintain in a pool of emergency identifiers. A registration record could be maintained in a registration record database to associate a given UE with a given temporary emergency call back identifier.

### PRIORITY STATEMENT UNDER 35 U.S.C S.119 (e) & 37 C.F.R. S.1.78

This non-provisional patent application claims priority based upon the prior U.S provisional patent applications entitled “TEMPORARY EMERGENCY CALL BACK IDENTIFIER”, application No. 60/852,010, filed Oct. 17, 2006, in the name of Lila Madour and Eric Turcotte.

### TECHNICAL FIELD

The present invention relates to emergency calls handling in telecommunications networks and, more precisely, to enabling emergency call back functionality for emergency calls in telecommunications networks.

### BACKGROUND

The 3GPP Technical Specification ‘3GPP TS 23.003 V7.1.0 (2006-09)’ herein incorporated by reference and referred to as 23.003 hereinafter is related to Numbering, addressing and identification.

The 3GPP Technical Specification ‘3GPP TS 23.167 V7.2.0 (2006-09)’ herein incorporated by reference and referred to as 23.167 hereinafter is related to IP Multimedia Subsystem (IMS) emergency sessions.

23.003 specifies that, for a User Equipment (UE), one or more Public Service Identity or Public User Identify (PUI) are stored in its associated Home Subscriber Server (HSS). An example of PSI is a Tel URI (see IETF RFC 3966 herein incorporated by reference). If a UE wants to be reachable from the Public Switched Telephone Network (PSTN), it needs to have at least one Telephone Universal Resource Identifier (Tel URI) associated thereto in the HSS.

If a UE already IMS-registered requires emergency assistance, 23.167 specifies that the UE shall perform a registration (i.e. emergency registration) for the support of emergency services. The UE shall use a special emergency PUI in the emergency registration request. The implicit registration set of the special emergency PUI shall contain an associated Tel URI that is used to call back the user from the PSTN. A UE is called back if, for instance, the communication was improperly lost.

The previous scenario applies to UE roaming (i.e. in a visited network). In the case where a UE is already IMS-registered and is not roaming (i.e. is in its home network), the UE may skip the additional emergency registration, which implies that no associated Tel URI is used to call back the user from the PSTN.

In order to handle feature interaction at call back, the associated Tel URI of the special emergency PUI that is used to call back the user from the PSTN should be a Tel URI dedicated to emergency situations. It does not need nor is it meant to be publicly known to the UE or any instance other than an eventual emergency service provider (e.g., Public Safety Answering Point (PSAP)) receiving the emergency assistance request.

Following the teachings established by 23.003 and 23.167, each UE should, thus, have a dedicated Tel URI maintained in its HSS for emergency assistance requests.

Having a Tel URI reserved for a specific UE implies reserving a corresponding number in a related numbering plan. Thus, reserving a Tel URI used in emergency situation for each UE would add pressure on the already constraints numbering plans.

The present invention provides a solution that alleviate the described problem.

### SUMMARY

A first aspect of the invention is directed to a method for providing a temporary emergency call back identifier to a User Equipment (UE) for use by an emergency assistance provider in a telecommunications network. The method comprises the steps of receiving an emergency registration request in the telecommunications network sent from the UE and, in view of the emergency registration request, providing an emergency registration to the UE in the telecommunications network. For doing so, the method comprises a step of assigning a temporary emergency call back identifier to the UE in the telecommunications network. The temporary emergency call back identifier is valid for a period of time that does not exceed the duration of the emergency registration.

A second aspect of the present invention is directed to a network node located in a telecommunications network that comprises a registration record database, a pool of emergency identifiers and an emergency management module. The registration record database maintains registration records associating a User Equipment (UE) identifier with a temporary emergency call bask identifier. The emergency management module receives an emergency registration indication associated to a UE. In response to the emergency registration request, emergency management module assigns a temporary emergency call back identifier to the UE from the pool of emergency identifiers and adds a registration record in the registration record database, registration record associating the UE with the temporary emergency call back identifier. The temporary emergency call back identifier is valid for a period of time that do not exceed the duration of an emergency registration of the UE.

### BRIEF DESCRIPTION OF THE DRAWINGS

A more complete understanding of the present invention may be gained by reference to the following ‘Detailed description’ when taken in conjunction with the accompanying drawings wherein:

FIG. 1 is an exemplary telecommunications network topology diagram in accordance with the teachings of the present invention;

FIG. 2 is a flow chart and nodal operation diagram of a suggested handling of an emergency assistance request in accordance with the teachings of the present invention;

FIG. 2B is a flow chart and nodal operation diagram of an alternate handling of an emergency assistance request in accordance with the teachings of the present invention; and

FIG. 3 is a modular representation of a network node in accordance with the teachings of the present invention.

### DETAILED DESCRIPTION

The present invention suggests assigning a temporary emergency call back identifier to a User Equipment (UE) for the duration of an emergency registration of a UE. The emergency registration is triggered by a need for emergency assistance. The temporary emergency call back identifier is thus likely to be assigned for a specific period of time equivalent to the duration of the emergency registration (e.g., 17 minutes). The temporary emergency call back identifier could also be released before the end of the emergency registration if it is possible to determine that the emergency assistance is fulfilled appropriately (detection or reception of message to this end). In the context of IP Multimedia Subsystem (IMS), the temporary emergency call back identifier (e.g., Emergency Tel URI (E-Tel URI)) could be assigned by a Home Subscriber Server (HSS) or a Serving-Call Session Control Function (S-CSCF). The HSS or S-CSCF could use a pool of emergency identifier in which the temporary emergency call back identifiers are maintained for assignment to requesting UEs.

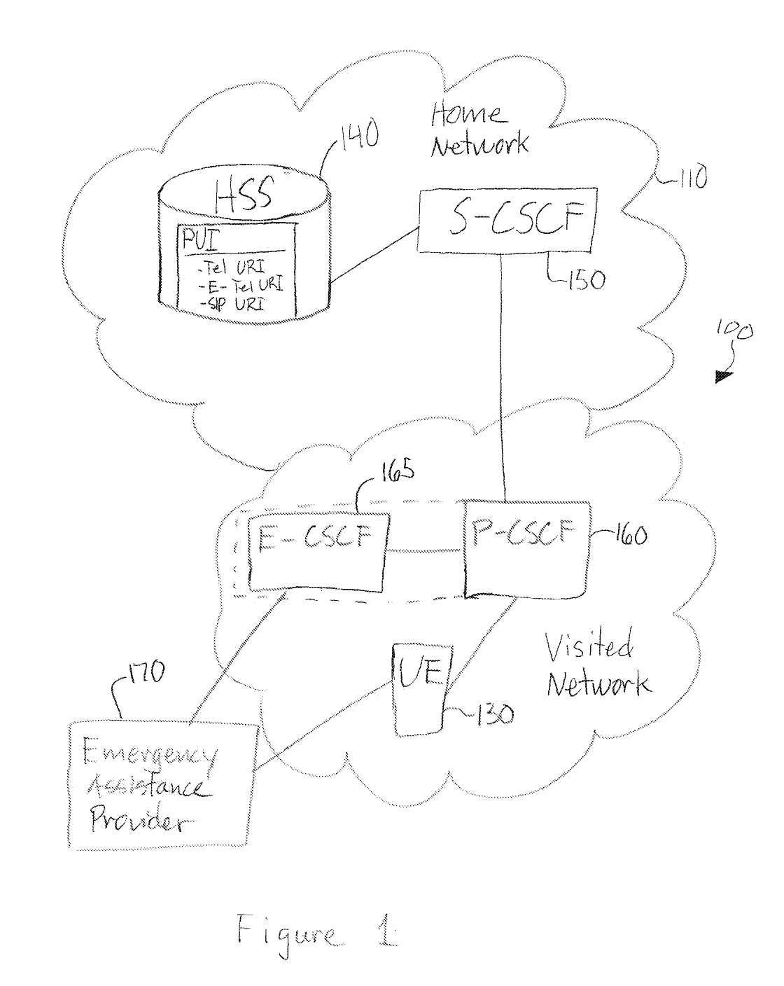

Reference is now made to the drawings in which FIG. 1 shows an exemplary telecommunications network 100 topology diagram in accordance with the teachings of the present invention. The example of FIG. 1 is taken from the perspective of a User Equipment (UE) 130 registered in the exemplary network 100. The exemplary network 100 shown comprises a home network 110 portion and a visited network 120 portion. The UE 130 is shown in the visited network 120. FIG. 1 further shows a Home Subscriber Server (HSS) 140 and a Serving-Call Session Control Function (S-CSCF) 150 both in the home network 110. A Proxy-CSCF (P-CSCF) 160 and an Emergency-CSCF (E-CSCF) 165 are shown in the visited network 120. The E-CSCF 165 could be or not collocated with the P-CSCF 160, as shown by the dotted line. An Emergency Assistance Provider (EAP) 170 is also shown in the exemplary network 100, but outside the home network 110 and visited network 120. This is an exemplary location, which do not affect the teachings of the invention. However, it should be mentioned that efforts are made to identify and reach the EAP 170 that serves the geographic location where the UE is currently located.

The HSS 140, the S-CSCF 150, the P-CSCF 160 and the E-CSCF 165 are a part of a control plane used to transport signaling while the actual session media do not transit through those nodes. Other nodes used in the control and media planes are not shown as they do not affect the teachings or functioning of the invention (e.g., Interrogating-CSCF (I-CSCF)).

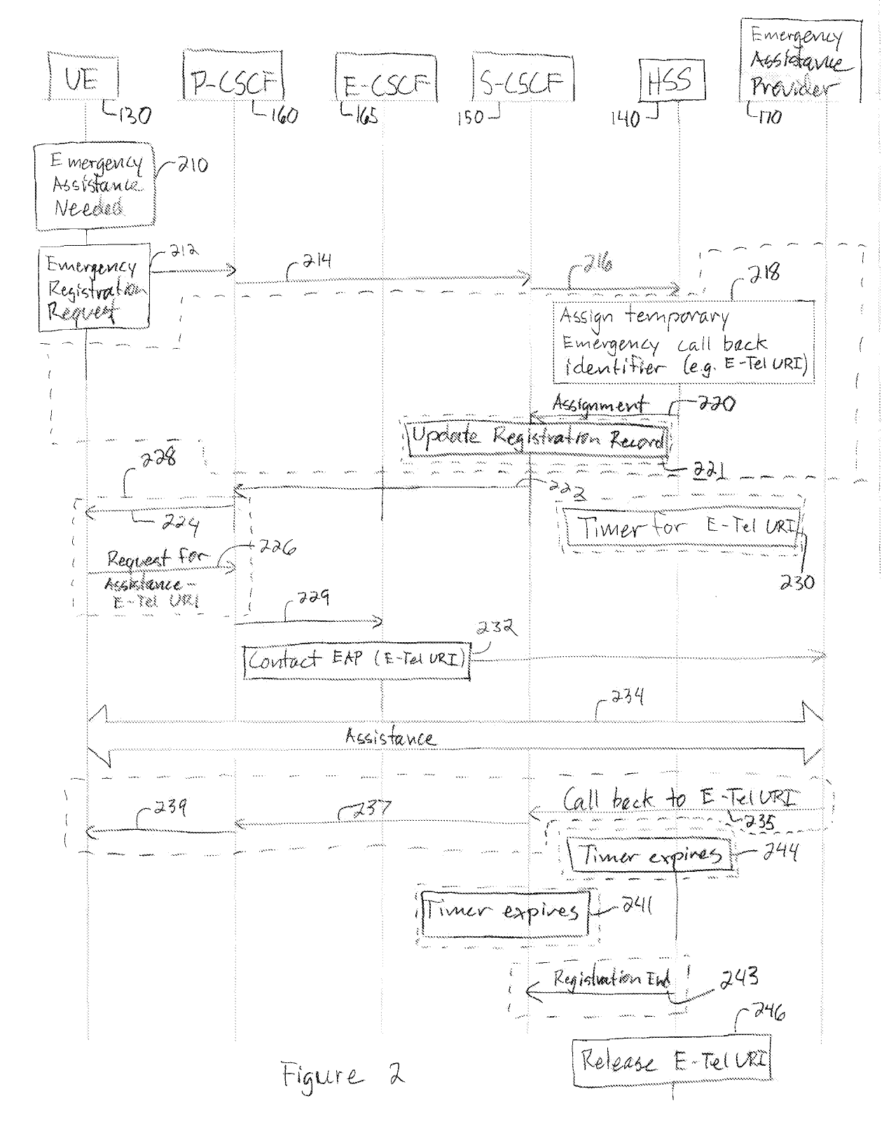

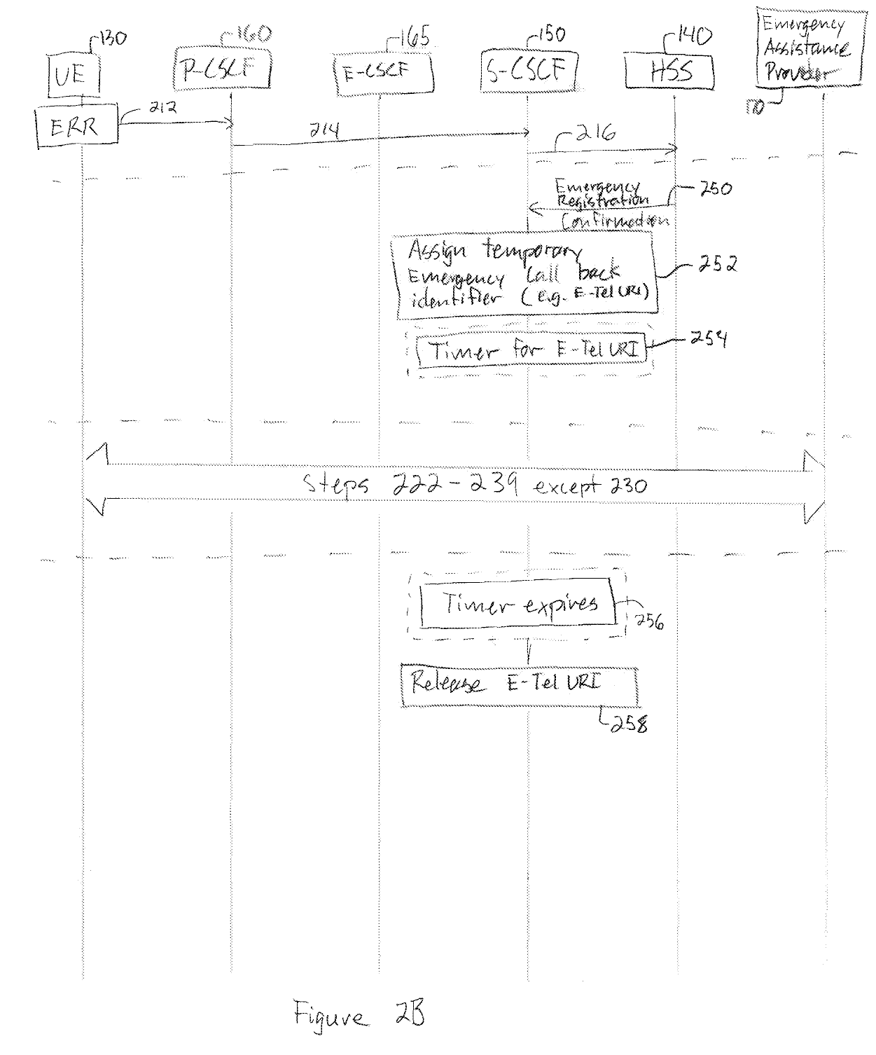

FIG. 2 shows a flow chart and nodal operation diagram of an emergency assistance request in accordance with the teachings of the present invention. The example shows how to provide a temporary emergency call back identifier to the UE 130 for potential use by the emergency assistance provider 170 in the telecommunications network 100.

The UE 130 has to express a need for emergency assistance 210. Of course, a user (not shown) of the UE 130 is, in fact, the source of the expression of the need of emergency assistance 210. We shall, for simplicity reason, refer to the UE 130 to designate the UE 130 and its user(s).

Thereafter, the UE 130 sends an emergency registration request 212, which is received in the telecommunications network 100. In view of the emergency registration request 212, the telecommunications network 100 causes a temporary emergency call back identifier (e.g., Emergency Tel URI (E-Tel URI) to be assigned to the UE 130 (step 218). In the example of FIG. 2, the emergency registration request 212 is received by the P-CSCF 160, which forwards it into 214 to the S-CSCF, which in turn, forwards it into 216 to the HSS 140. The HSS 140 provides, in the example of FIG. 2, an emergency registration to the UE 130 upon reception of the emergency registration request 212 (forwarded to the HSS 140 into 216). The HSS 140 also assigns the temporary emergency call back identifier to the UE 218 by sending an assignment message 220 comprising the temporary emergency call back identifier towards the UE 130 or the P-CSCF 160. The assignment message 220 is likely to be incorporated in an emergency registration confirmation message sent from the HSS 140 towards the UE 130. The assignment message 220 is received by the S-CSCF 150, which can potentially update a local registration record (step 221) to note the link between the temporary emergency call back identifier and the UE 130. The S-CSCF 150 then forwards the assignment message 220 into 222 to the P-CSCF 160. The P-CSCF 160 forwards the assignment message 222 from into 224 towards the UE 130. The UE 130 then replies with a request for assistance 226 comprising the temporary emergency call back identifier. The P-CSCF 160 then initiate a request for assistance 229 on behalf of the UE 130 towards the E-CSCF 165. The request for assistance 229 comprises the temporary emergency call back identifier received in the request for assistance 226 or in the assignment message 222. Upon reception of the request for assistance 229, the E-CSCF 165 initiates contact with the emergency assistance provider 170 (step 232). The contact 232 can be seen as a delivery, for the UE 130 towards the EAP 170, of an emergency assistance request comprising the temporary emergency call back identifier.

Optionally, the request for assistance 229 may also be initiated by the P-CSCF 160 directly after reception of the assignment message 222. It is theoretically possible for the P-SCCF 160 to relate the information found therein to the UE 130. While the request for assistance 229 can be sent by the P-CSCF 160 without explicit request from the UE 130, it does not fall within the usual P-CSCF 160 responsibilities to spontaneously initiate such a request 229. Nevertheless, the messages 224 and 226 are shown in a dotted box 228 as they are not mandatory to the proper functioning of the invention.

The emergency assistance provider 170 and the UE 130 are now able to communicate 234 thereby enabling the required assistance to be provided (description of which is outside the scope of the present invention).

The assignment 218 performed by the HSS 140 may be described, in the context of FIG. 2, as an addition of the temporary emergency call back identifier in a profile associated with the UE 130 maintained in the HSS 140. In order to do that, the HSS 140 may maintain a pool of temporary identifiers. In such a case, the HSS 140 removes the assigned temporary emergency call back identifier from the pool of temporary identifiers upon addition in the associated profile of the UE 130.

To further show how the emergency temporary call back identifier could be used, a call back initiation message 235 made to the emergency temporary call back identifier is shown from the EAP 170 towards the UE 130. The call back initiation message 235 is shown from the EAP 170 to the S-CSCF 150. However, some other messages are likely to be necessary before the call back initiation message 235 or in conjunction therewith (e.g., involving an I-CSCF, not shown). Upon reception of the call back initiation message 235, the S-CSCF 150 retrieves necessary information to continue the initiation of the call back towards the temporary emergency call back identifier used in the call back initiation message 235. The necessary information is likely to be fetched in the registration record of the S-CSCF 150 (if it exists), but could also be requested from some other nodes (e.g., the HSS 140). The S-CSCF 150 is able to determine that the temporary emergency call back identifier is related to an emergency call and can therefore handle terminating features of the call in accordance with specific instructions related to an emergency call (or call back). Once the S-CSCF 150 has the necessary information, it proceeds, possibly taking into account the emergency nature of the request, with the initiation of a corresponding call towards the UE 130 (to which the temporary emergency call back identifier is associated). For doing so, the S-CSCF 150 sends an initiation message 237 towards the P-CSCF 160, which forwards it to the UE 130 into 239. A call back is thereafter established as any other call would be (not shown).

In order to achieve the purpose of the present invention, the assigned temporary emergency call back identifier needs to be freed for reassignment following its potential use by, for instance, the EAP 170 or another unit (as shown in steps 235-239). This is shown in the example of FIG. 2 as a release of the temporary emergency call back identifier (step 246). This may mean returning the temporary emergency call back identifier to the pool of temporary identifiers maintained in the HSS 140.

There are many ways to achieve the step of releasing the temporary emergency call 246. A proposed solution is to use a timer (230) that the HSS 140 starts following the emergency registration that corresponds, incidentally, to the assignment of the temporary emergency call back identifier (218). This timer 230 may have a duration set following various criterions, which are outside the scope of the present invention (e.g., length of typical assistance calls, maximum time taken to geographically locate the source of an assistance call, etc.). Upon expiration of the timer (step 244), the step 246 of releasing the temporary emergency call back identifier may be performed. If the timer 230 is used, then the optional step 221 in the S-CSCF 150 of updating the local registration record could also comprise starting an equivalent timer in the S-CSCF 150. Upon expiration of the equivalent timer, the S-CSCF 150 could remove the link between the temporary emergency call back identifier and the UE 130 from its registration record (optional step 241). Alternatively, if the S-CSCF 150 does not maintain the equivalent timer, it could receive an indication of emergency registration end from the HSS 140 (optional message 243).

Another solution is to receive a release message (not shown) from the UE towards the HSS 140. A similar release message could also be received from the EAP 170 (not shown). The reception of a release message at the HSS 140 thereafter triggers the release 246. Yet another solution is to use existing or new triggers to detect the end of an assistance session related to the assistance 234 (not shown). The detection thereafter triggers the release 246. It should also be noted it is an envisioned possibility to knowingly avoid treating release messages (e.g., that could come from the UE 130 or the EAP 170). The purpose of such a feature would be to avoid releasing a temporary emergency call back identifier reputed obsolete, but that would still be needed at a later time (e.g., based on newly received information).

It is foreseen that the solution involving the timer (steps 230 and 244) is one of the best approaches as it does not require further standardization compared to the existing standard status since the timer 230 is already suggested to keep track of emergency registrations. However, further options may include the release messages or detection used alone or in conjunction with timer 230 (e.g., before expiration of the timer 230 to shorten the period during which a given emergency temporary call back identifier is used).

The example of FIG. 2 shows the HSS 140 as being the node assigning the temporary emergency call back identifier. It is also envisioned that the S-CSCF 150 could provide the same level functionalities, as can be seen on FIG. 2B, which shows a flow chart and nodal operation diagram of an alternate handling of an emergency assistance request in accordance with the teachings of the present invention. The steps 210 to 216 of FIG. 2 remain the same in the example of FIG. 2B. Upon reception of the emergency registration request 216, the HSS 140 sends an emergency registration confirmation 250 towards the UE 130. the S-CSCF 150 receives the emergency registration confirmation 250 and assigns a temporary emergency call back identifier (e.g., Emergency Tel URI (E-Tel URI) to the UE 130 (step 252, which is similar to the step 218). The S-CSCF 150 may then start a timer (step 254, which is similar to the step 230) following the assignment of the temporary emergency call back identifier (252). Thereafter, the example of FIG. 2B follows the example of FIG. 2 for the steps 222 to step 239 (with the exception of step 230, which is not needed in FIG. 2B, as it is replaced by the step 254, if needed). As noted in relation with the example of FIG. 2, some steps are optional or not necessarily needed. The same explanations apply to the steps in relation to the example of FIG. 2B. The example of FIG. 2B follows with the potential expiration of the timer of the step 254 (step 256). The step 256 (or some other messages or triggers) is followed by a release of the emergency temporary call back identifier (step 258, which is similar to the step 246). This may mean returning the temporary emergency call back identifier to a pool of temporary identifiers maintained in the S-CSCF 150, just as mentioned in relation to the HSS 140.

Ideally, the timers 230, 254 could also be refreshed or restarted following detection of events in the network 100. For instance, the timers 230, 254 could be set (or reset) at the end of the assistance providing 234. In such a scenario, the length of the timer does not have to take into account the duration of the assistance providing 234. However, the information concerning network events such as the end of the assistance providing 234 is not meant, in the current state of the standard, to travel back to the home network 110 (i.e., towards the HSS 140 or the S-CSCF 150).

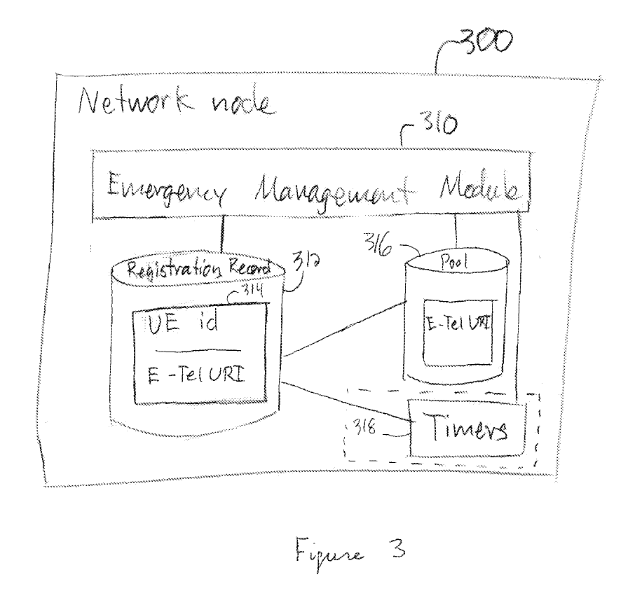

FIG. 3 shows a network node 300 located in a telecommunications network that comprises an emergency management module 310, a Registration Record database 312 and a pool of emergency identifiers 316 and that can comprise timers 318. The Registration Record database 312 maintains association between specific User Equipments (UEs) (e.g., using a UE Identifier of any kind) and a temporary emergency call back identifier (e.g., E-Tel URI). The association may comprise much more information (which is outside the scope of the present invention). The emergency management module 310 receives an emergency registration indication (e.g., emergency registration request or emergency registration confirmation) associated to a specific UE. In response to the emergency registration indication, the emergency management module 310 assigns a temporary emergency call back identifier to the specific UE from the pool of emergency identifiers 316 and adds a registration record 314 to this effect in the Registration Record database 312. The emergency management module 310 may further, following the emergency registration indication, start a timer (maintained in 318). The timer could optionally have a duration that is identical to the duration of an emergency registration. In other words, the timer could be the same as a timer used to track the duration of an emergency registration. If the timer is used, upon expiration of the timer, the emergency management module 310 removes the registration record 314 from the Registration Record database 312 thereby freeing the temporary emergency call back identifier. The emergency management module 310, upon release of the temporary emergency call back identifier, may also return the temporary emergency call back identifier to the pool of emergency identifiers 316. The emergency management module 310 may also receive a release message (e.g., sent from the specific UE or another node such as a HSS, a P-CSCF or an emergency assistance provider). Following the reception of the release message, the emergency management module 310 removes the registration record 314 from the Registration Record database 312 thereby freeing the temporary emergency call back identifier. It should be noted that the release messages and the timers 318 could be used in conjunction. However, in the best envisioned scenario, the timers 318 would represent the longest possible duration of a period of validity of the temporary emergency call back identifier. In this best (but still exemplary) scenario, the period of validity could be shorten by the reception of a release message. Thus, if the timers 318 represent the timers used to keep track of the emergency registrations, the period of validity of the temporary emergency call back identifier would be equivalent to the duration of an emergency registration unless it is shorten by the reception of a release message. As can be easily inferred from the examples of FIG. 2 and FIG. 2B, the network node 300 could be, for example, a HSS or a S-CSCF.

The innovative teachings of the present invention have been described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views and the various elements depicted are not necessarily drawn to scale.

What is claimed is:

1. A method for providing a temporary emergency call back identifier to a User Equipment (UE) for use by an emergency assistance provider in a telecommunications network comprising the steps of:
receiving an emergency registration request in the telecommunications network sent from the UE;
in view of the emergency registration request, providing an emergency registration to the UE in the telecommunications network; and
assigning a temporary emergency call back identifier to the UE in the telecommunications network, wherein the temporary emergency call back identifier is valid for a period of time that does not exceed the duration of the emergency registration.

2. The method of claim 1 further comprising a step of delivering in the telecommunications network, for the UE, an emergency assistance request comprising the temporary emergency call back identifier at the emergency assistance provider.

3. The method of claim 1 wherein the step of receiving the emergency registration request is performed by a Proxy-Call Session Control Function (P-CSCF) in a visited portion of the telecommunications network where the UE is located and wherein the step of assigning the temporary emergency call back identifier is performed at a Home Subscriber Server (HSS) of the UE in a home portion of the telecommunications network.

4. The method of claim 1 wherein the step of receiving the emergency registration request is performed by a Proxy-Call Session Control Function (P-CSCF) in a visited portion of the telecommunications network where the UE is located and wherein the step of assigning the temporary emergency call back identifier is performed by forwarding the emergency registration to a Serving-CSCF (S-CSCF) in a home portion of the telecommunications network and assigning, at the S-CSCF, the temporary emergency call back identifier to the UE.

5. The method of claim 3 further comprising a step of adding the temporary emergency call back identifier in a registration record database associated with the UE maintained in the HSS.

6. The method of claim 5 further comprising a step of removing, in the HSS, the temporary emergency call back identifier from a pool of temporary identifiers maintained in the HSS.

7. The method of claim 4 further comprising a step of adding the temporary emergency call back identifier in a registration record database associated with the UE maintained in the S-CSCF.

8. The method of claim 7 further comprising a step of removing, in the HSS, the temporary emergency call back identifier from a pool of temporary identifiers maintained in the S-CSCF.

9. The method of claim 1 further comprising a step following the step of providing the emergency registration, starting a timer.

10. The method of claim 9 further comprising the steps of, upon expiration of the timer, ending the emergency registration thereby releasing the assignment of the temporary emergency call back identifier from the UE.

11. The method of claim 5 further comprising the steps of receiving a release message from the UE at the P-CSCF, forwarding the release message from the P-CSCF to the HSS and releasing, at the HSS, the temporary emergency call back identifier.

12. The method of claim 7 further comprising the steps of receiving a release message from the UE at the P-CSCF, forwarding the release message from the P-CSCF to the S-CSCF and releasing, at the S-CSCF, the temporary emergency call back identifier.

13. The method of claim 2 wherein the step of delivering the emergency assistance request comprises sending the emergency assistance request from an Emergency-Call Session Control Function (E-CSCF) in a visited portion of the telecommunications network where the UE is located to the emergency assistance provider.

14. A network node located in a telecommunications network that comprises:
a registration record database that maintains registration records associating a User Equipment (UE) identifier with a temporary emergency call bask identifier;
a pool of emergency identifiers;
an emergency management module that:
receives an emergency registration indication associated to a UE;
in response to the emergency registration request:
assigns a temporary emergency call back identifier to the UE from the pool of emergency identifiers; and
adds a registration record in the registration record database, registration record associating the UE with the temporary emergency call back identifier; and
wherein the temporary emergency call back identifier is valid for a period of time that do not exceed the duration of an emergency registration of the UE.

15. The network node of claim 14 wherein the emergency management module further:
following addition of the registration record, starts a timer; and
upon expiration of the timer, removes the registration record from the registration record database.

16. The network of claim 15 wherein the emergency management module, upon removal of the registration record, returns the temporary emergency call back identifier to the pool of emergency identifiers.

17. The network node of claim 14 wherein the emergency management module, following reception of a release message, removes the registration record from the registration record database.
